(19) United States
(12) Patent Application Publication
(10) Pub. No.: US 2012/0271208 A1
(43) Pub. Date: Oct. 25, 2012

(54) Head Massaging Device

(76) Inventor: Henry Tang-Yu YEH, Taipei City (TW)

(21) Appl. No.: 13/245,704

(22) Filed: Sep. 26, 2011

(30) Foreign Application Priority Data
Apr. 20, 2011 (TW) 100206972

(51) Int. Cl. A61H 7/00

(52) U.S. Cl. 601/137

(57) ABSTRACT

A head massaging device includes a gripping handle and a resilient pawl arrangement provided at an end of the gripping handle. The resilient pawl arrangement is consisted of a plurality of first resilient pawls and second resilient pawls which have different lengths, and the plurality of resilient pawls are extended in arc shape and arranged to form at least one circle of the resilient pawls, so that varied massaging pressure is provided within a predetermined area. The head massaging device further comprises a ball shaped pressing portion at a distal end of each of the plurality of the resilient pawls remote from the gripping handle, and the pressing portion can be any kinds of energy radiator.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a head massaging device, and more particularly to a head massaging device which is convenient to use and capable of providing varied massaging pressure within a predetermined area.

2. Description of Related Arts

A conventional massaging device, as disclosed in a Taiwan patent publication D135441, comprises a gripping handle and a fork portion provided at an end of the gripping handle. When applied to use, the fork portion is pressing against a position of the body to achieve a predetermined massaging effect. But the fork portion is generally bulky in size, the structure is simple, and the fork portion also lacks a resilient ability. As a result, the massaging performance is limited, tiny subtle positions may not receive a massaging pressure, and the massaging device also cannot provide a comfortable and enjoyable massaging for a user. The above disadvantages result in a great shortcoming to the use of the massaging device.

A skin scraping and massaging comb structure disclosed in M333825 and a massaging brush described in D131632 comprise a plurality of transverse thin pillars protrudely and intensely provided at an end of a gripping handle, so that when in use the plurality of thin pillars are pressing against the head and then sliding to achieve a massaging effect. But this kind of massaging device is only suitable for combing in a single direction and a user has to transversely grip the handle which also adds inconvenience to the use.

As another example, a conventional massaging device disclosed in D128593 comprises a plurality of fork portions provided at an end of a gripping handle, wherein each of the fork portion has a sliding ball at an distal end thereof and the sliding ball has a plurality of pillars protrudely and intensely provided on an outer surface thereof, so that when in use the massaging effect can be achieved via the sliding movement of the sliding ball on the surface of the human body. However, the structure of the sliding ball with pillars on the surface thereof is only designed for massaging during movement of the sliding ball, and cannot apply pressure to a predetermined point. And thus this massaging device also has disadvantages when in use.

Considering the drawbacks of the above mentioned massaging device, another massing comb which is shown in FIG. 1 is developed and appeared in the market. The massaging comb comprises a griping handle 4 and a plurality of resilient diverging massaging comb strips 5 provided at an end of the gripping handle 4, wherein each of the massaging comb strips 5 has a ball body 51 or protruding arc shaped surface at an distal end thereof, so that when in use, since the resilient massaging comb strips 5 can bend and deform when a force is applied thereto, the pressing position and pressure can be adjusted with respect to different requirements. What's more, with the help of the smooth ball body 51, a user can enjoy varied massaging experience when combing his head. But according to the design, the massaging comb strips 5 are arranged in straight lines, so that the massaging effect of a predetermined area can be only achieved by an action of combing. Furthermore, it's hard to obtain some changes on operation manners as well as different functions of the massing comb.

### SUMMARY OF THE PRESENT INVENTION

The main object of the present invention is to provide a head massaging device which provides a position-setting effect by reciprocal supporting and achieves a massaging effect on a predetermined position by repeatedly pressing.

Another object of the present invention is to provide a head massaging device to obtain a massaging effect within a predetermined area with varied applying force, so that some changes in the application of the massaging device can be provided.

Additional advantages and features of the invention will become apparent from the description which follows, and may be realized by means of the instrumentalities and combinations particular point out in the appended claims.

According to the present invention, the foregoing and other objects and advantages are attained by a head massaging device comprising a gripping handle and a resilient pawl arrangement provided at an end of the gripping handle, wherein the resilient pawl arrangement is consisted of a plurality of resilient pawls having bending and retracting flexibility, and the plurality of resilient pawls are arranged to form at least one circle of the resilient pawls.

Preferrably, the plurality of resilient pawls are extended in arc shape.

Preferrably, the plurality of resilient pawls comprises a plurality of first resilient pawls having a first length and a plurality of second resilient pawls having a second length.

Preferrably, the plurality of first resilient pawls and the plurality of second resilient pawls are distributed in such a manner that each of the plurality of first resilient pawls is located intermediate two adjacent of the plurality of second resilient pawls.

Preferrably, the head massaging device further comprises a ball shaped pressing portion at a distal end of each of the plurality of the resilient pawls remote from the gripping handle.

Preferrably, the head massaging device further comprises a ball shaped massaging portion at an end of the gripping handle remote from the resilient pawl arrangement.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a head massaging device according to the prior art.

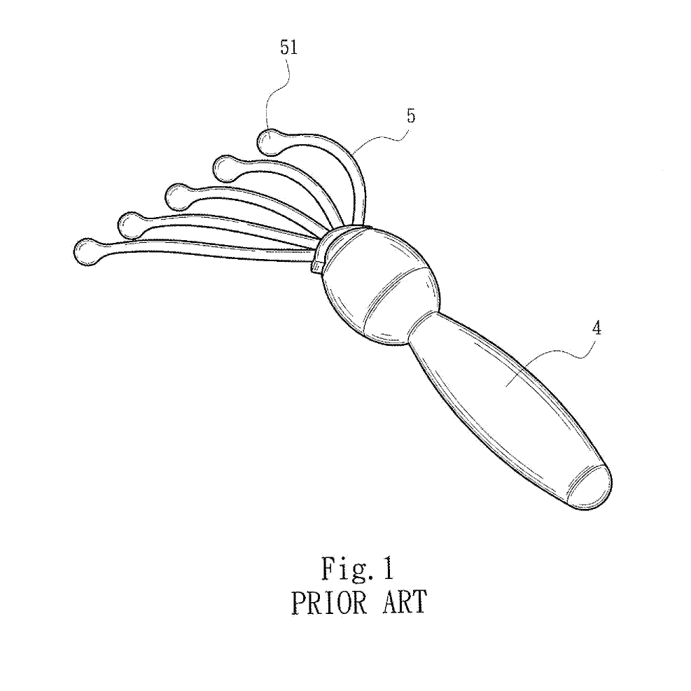

FIG. 2 is a perspective view of a head massaging device according to a preferred embodiment of the present invention.

FIG. 3 is a schematic view illustrating the application of the head massaging device according to the above preferred embodiment of the present invention.

### DETAILED DESCRIPTION OF THE PREFERRED EMBODIMENT

The following description is disclosed to enable any person skilled in the art to make and use the present invention. Preferable embodiments are provided in the following description only as examples and modifications will be apparent to those skilled in the art. The general principles defined in the following description would be applied to other embodiments, alternatives, modifications, equivalents, and applications without departing from the spirit and scope of the present invention.

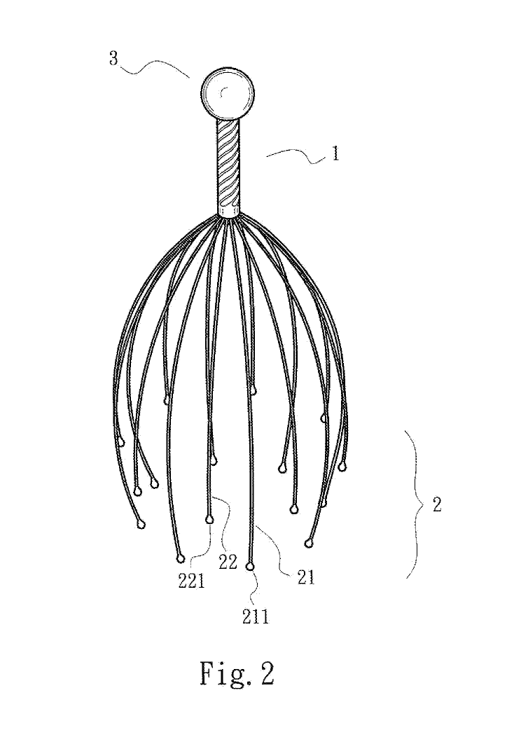

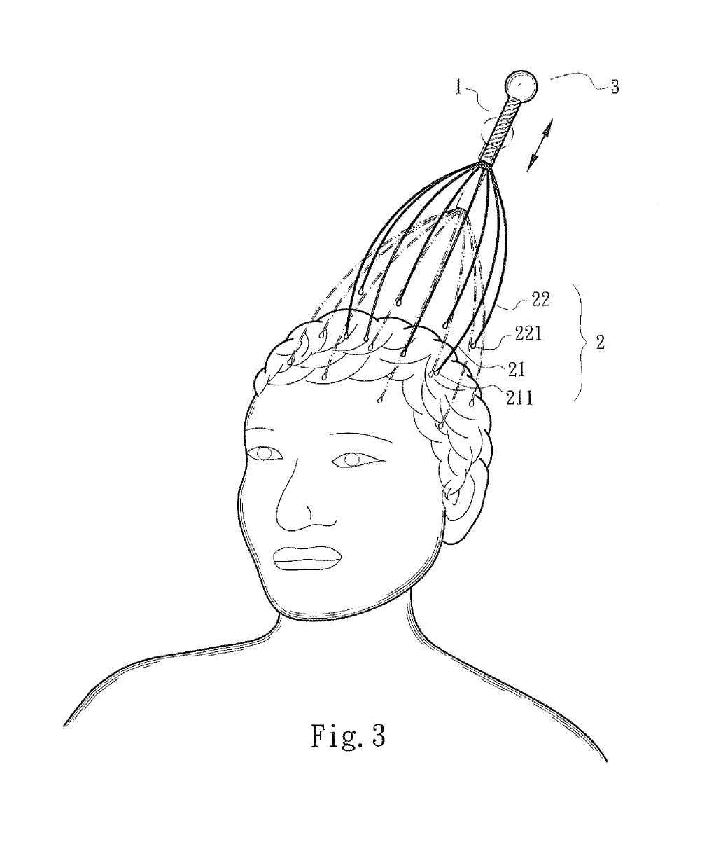

Referring to FIG. 2 to FIG. 3 of the drawings, a massaging device according to a preferred embodiment of the present invention is illustrated, wherein the massaging device comprises a griping handle 1, a resilient pawl arrangement 2, and a massaging portion 3. The gripping handle 1 is elongated in shape or any other shape which is adapted for gripping. The resilient pawl arrangement 2, which is provided at an end of the gripping handle 1, comprises a plurality of first resilient pawls 21 each having a first length and a plurality of second resilient pawls 22 each having a second length, the first length is relatively longer than the second length, the plurality of first resilient pawls 21 and the plurality of second resilient pawls 22 are distributed in such a manner that each of the plurality of first resilient pawls 21 is located intermediate two adjacent of the plurality of second resilient pawls 22 and arranged to form a circle of the resilient pawls. Each of the first resilient pawls 21 and each of the resilient pawls 22, which have bending and attracting ability, are extended in arc shape respectively. Each of the plurality of the first resilient pawls 21 and the plurality of second resilient pawls 22 comprises a ball shaped pressing portion 211, 221 at a distal end thereof remote from the gripping handle 1. Accordingly, each of the pressing portions 211, 221 can be an energy radiator which emits different kinds of energy (magnetic, far-infrared, or negative charged) if required. The massaging portion 3, which is provided at end of the gripping handle 1 remote from the resilient pawl arrangement 2, is a ball shaped body or convex arc shaped body.

When in use, an operator grips on the gripping handle 1 and directs the resilient pawl arrangement 2 to press against a person's head. Since the plurality of first resilient pawls 21 having a relatively longer length is arranged in a circle, a reciprocal supporting effect is provided, so that the resilient pawl arrangement 2 is not easy to move in a transverse direction. And then, the operator can actuate the resilient pawl arrangement 2 via the griping handle 1 to press the head back and forth, so that the plurality of resilient pawls 21 are corresponding expanding outwardly and then return to an original state. When the plurality of first resilient pawls 21 are expanding outwardly, the plurality of second resilient pawls 22 are also pressing against the head. Since the plurality of first resilient pawls 21 and the plurality of second resilient pawls have different lengths, so that the pressing positions (The plurality of first resilient pawls 21 have a relatively lager pressing area, while the plurality of second resilient pawls 22 are pressing against the relatively central positions and have a relatively smaller area) and pressure are varied. And thus varied massaging effects are provided. Furthermore, the pressing portions 211, 221 which have energy emitting characteristic can emit different predetermined kind of energy (magnetic, far-infrared, or negative charged), so that the enjoyable and comfortable effect can be improved. It is worth mentioning that the massaging portion 3 not only functions as a blocking barrier of the end of the gripping handle to facilitate gripping, but also can be directed to press against the head by holding onto the gripping handle 1 when a relatively stronger pressing force is required, so that different massaging effect can be obtained.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1: A head massaging device, comprising:
a gripping handle, and
a resilient pawl arrangement provided at an end of said gripping handle, wherein said resilient pawl arrangement is consisted of a plurality of resilient pawls having bending and retracting flexibility, and said plurality of resilient pawls are arranged to form at least one circle of said resilient pawls.

2: The head massaging device, as recited in claim 1, wherein said plurality of resilient pawls are extended in arc shape.

3: The head massaging device, as recited in claim 1, wherein said plurality of resilient pawls comprises at least two kinds of resilient pawls, wherein each kind of said resilient pawls has a different length.

4: A head massaging device, as recited in claim 3, wherein said plurality of resilient pawls having different lengths are distributed in such a manner that each of said plurality of first resilient pawls is located intermediate two adjacent of said plurality of second resilient pawls.

5: The head massaging device, as recited in claim 1, further comprising a ball shaped pressing portion at a distal end of each of said plurality of resilient pawls remote from said gripping handle.

6: The head massaging device, as recited in claim 3, further comprising a ball shaped pressing portion at a distal end of each of said plurality of resilient pawls remote from said gripping handle.

7: The head massaging device, as recited in claim 5, wherein said basing portion is an energy radiator.

8: The head massaging device, as recited in claim 6, wherein said basing portion is an energy radiator.

9: The head massaging device, as recited in claim 1, further comprising a ball shaped massaging portion at an end of said gripping handle remote from said resilient pawl arrangement.

10: The head massaging device, as recited in claim 3, further comprising a ball shaped massaging portion at an end of said gripping handle remote from said resilient pawl arrangement.

11: The head massaging device, as recited in claim 4, further comprising a ball shaped massaging portion at an end of said gripping handle remote from said resilient pawl arrangement.

12: The head massaging device, as recited in claim 5, further comprising a ball shaped massaging portion at an end of said gripping handle remote from said resilient pawl arrangement.

13: The head massaging device, as recited in claim 6, further comprising a ball shaped massaging portion at an end of said gripping handle remote from said resilient pawl arrangement.

14: The head massaging device, as recited in claim 7, further comprising a ball shaped massaging portion at an end of said gripping handle remote from said resilient pawl arrangement.

15: The head massaging device, as recited in claim 9, further comprising a ball shaped massaging portion at an end of said gripping handle remote from said resilient pawl arrangement.

16: The head massaging device, as recited in claim 2, wherein said plurality of resilient pawls comprises at least two kinds of resilient pawls, wherein each kind of said resilient pawls has a different length.

17: The head massaging device, as recited in claim 2, further comprising a ball shaped pressing portion at a distal end of each of said plurality of resilient pawls remote from said gripping handle.

18: The head massaging device, as recited in claim 2, further comprising a ball shaped massaging portion at an end of said gripping handle remote from said resilient pawl arrangement.

19: A head massaging device, as recited in claim 16, wherein said plurality of resilient pawls having different lengths are distributed in such a manner that each of said plurality of first resilient pawls is located intermediate two adjacent of said plurality of second resilient pawls.

20: The head massaging device, as recited in claim 16, further comprising a ball shaped pressing portion at a distal end of each of said plurality of resilient pawls remote from said gripping handle.

21: The head massaging device, as recited in claim 16, further comprising a ball shaped massaging portion at an end of said gripping handle remote from said resilient pawl arrangement.

22: The head massaging device, as recited in claim 17, wherein said basing portion is an energy radiator.

23: The head massaging device, as recited in claim 17, further comprising a ball shaped massaging portion at an end of said gripping handle remote from said resilient pawl arrangement.

24: The head massaging device, as recited in claim 18, further comprising a ball shaped massaging portion at an end of said gripping handle remote from said resilient pawl arrangement.

25: The head massaging device, as recited in claim 19, further comprising a ball shaped massaging portion at an end of said gripping handle remote from said resilient pawl arrangement.

26: The head massaging device, as recited in claim 20, further comprising a ball shaped massaging portion at an end of said gripping handle remote from said resilient pawl arrangement.

27: The head massaging device, as recited in claim 20, wherein said basing portion is an energy radiator.

28: The head massaging device, as recited in claim 22, further comprising a ball shaped massaging portion at an end of said gripping handle remote from said resilient pawl arrangement.
